(19) United States
(12) Patent Application Publication
(10) Pub. No.: US 2025/0324179 A1
(43) Pub. Date: Oct. 16, 2025

(54) SOLID-STATE IMAGING DEVICE

(71) Applicant: Samsung Electronics Co., Ltd., Suwon-si (KR)

(72) Inventor: Sangman HAN, Yokohama (JP)

(73) Assignee: Samsung Electronics Co., Ltd., Suwon-si (KR)

(21) Appl. No.: 19/175,675

(22) Filed: Apr. 10, 2025

(30) Foreign Application Priority Data
Apr. 12, 2024 (JP) 2024-064490
Dec. 31, 2024 (KR) 10-2024-0202690

(51) Int. Cl. H04N 25/78; G01S 7/4865; H04N 25/76; H04N 25/772

(52) U.S. Cl. CPC H04N 25/78; H04N 25/772; H04N 25/7795; G01S 7/4865

(57) ABSTRACT

Provided is a solid-state imaging device including a pixel including a photoelectric converter configured to photoelectrically convert light to generate electric charge, a plurality of charge accumulators each configured to accumulate the electric charge, and a plurality of transfer controllers configured to respectively control transfer of the electric charge to the plurality of charge accumulators from the photoelectric converter, a converter configured to generate a digital value that is based on the amount of electric charge accumulated in the plurality of charge accumulators, an adder configured to add the generated digital value to a digital value previously stored in the memory, and a driver configured to control the plurality of transfer controllers to store the resulting value of the addition in the memory.

### CROSS-REFERENCE TO RELATED APPLICATION

This application claims priority to Japanese Patent Application No. 2024-064490, filed on Apr. 12, 2024, in the Japanese Intellectual Property Office, and Korean Patent Application No. 10-2024-0202690, filed on Dec. 31, 2024, in the Korea Intellectual Property Office, the disclosures of which are incorporated by reference herein in their entireties.

### BACKGROUND

Embodiments of the present disclosure relate to a solid-state imaging device.

In the field of three-dimensional (3D) measurement or object recognition, the demand for time of flight (TOF) technology is increasing.

In TOF technology, multi-tap imaging sensors that include pixels each including a plurality of charge accumulators are being used. Based on the multi-tap imaging sensor, a distance to a subject may be measured with relatively high precision. In the multi-tap imaging sensor, it is not necessary for a plurality of charge accumulators included in each pixel to have the same characteristic.

However, due to the nature of semiconductor manufacturing technology, it may be difficult to identically manufacture all charge accumulators, and there is non-uniformity in the characteristics of a plurality of charge accumulators. Due to this, general multi-tap imaging sensors have a problem where the precision of measurement is reduced by the non-uniformity of tap characteristics.

Also, in general multi-tap imaging sensors, a read time may increase because reading of a pixel signal is performed by pixel row units for each subframe into which one frame is temporally divided, and due to this, there is a possibility that a motion artifact occurs in general multi-tap imaging sensors.

### SUMMARY

One or more embodiments provide a solid-state imaging device which may prevent the occurrence of a motion artifact and may measure a distance to a subject with improved precision.

According to an aspect of one or more embodiments, there is provided a solid-state imaging device including at least one pixel including a photoelectric converter configured to photoelectrically convert light to generate electric charge, a plurality of charge accumulators respectively configured to accumulate the electric charge generated by the photoelectric converter, and a plurality of transfer transistors respectively configured to control transfer of the electric charge from the photoelectric converter to the plurality of charge accumulators, a converter connected to the at least one pixel and configured to generate a digital value based on an amount of electric charge accumulated in the plurality of charge accumulators, a memory connected to the at least one pixel and configured to store the digital value, an adder connected to the at least one pixel and configured to add the digital value, generated by the converter, to a digital value previously stored in the memory, and a driver configured to add a digital value based on the amount of electric charge accumulated in one of the plurality of charge accumulators in a subframe next to a certain subframe, to a digital value based on the amount of electric charge accumulated in one of the plurality of charge accumulators in the certain subframe, and control the plurality of transfer transistors to store a summed value in the memory.

According to an aspect of one or more embodiments, there is provided a solid-state imaging device including a pixel array including a plurality of pixels, and a driver configured to generate a driving signal, wherein each of the plurality of pixels includes a photodiode configured to photoelectrically convert light to generate electric charge, a plurality of signal generators respectively configured to accumulate the electric charge generated by the photodiode and output a voltage based on an amount of accumulated electric charge, an analog-to-digital converter (ADC) integrator configured to convert the voltage into a first digital value and add the first digital value to a second digital value, and a memory configured to store the first digital value and the second digital value, wherein the second digital value is a digital value previously stored in the memory, and wherein the driving signal is a signal configured to control a first signal generator of the plurality of signal generators to output a voltage based on the amount of electric charge accumulated in the first signal generator in a certain subframe and a second signal generator of the plurality of signal generators to output a voltage based on the amount of electric charge accumulated in the second signal generator of the plurality of signal generators in a subframe adjacent to the certain subframe.

According to an aspect of one or more embodiments, there is provided an operating method of a solid-state imaging device including a plurality of charge accumulators, a memory, and an adder, the operating method including accumulating electric charge at different phase timings for each subframe among a plurality of continuous subframes based on the plurality of charge accumulators, generating a digital value corresponding to the different phase timings based on the amount of electric charge accumulated by the adder, and adding the digital value to a digital value previously stored in the memory, based on the adder, wherein the digital value previously stored in the memory is a digital value added by the adder in a subframe preceding a certain subframe, where the digital value is generated, of the plurality of continuous subframes.

### BRIEF DESCRIPTION OF DRAWINGS

Embodiments will be more clearly understood from the following detailed description taken in conjunction with the accompanying drawings in which:

FIG. 1 is a diagram illustrating a schematic configuration of a time of flight (TOF) system to which a solid-state imaging device is applied;

FIG. 2 is a circuit diagram illustrating a schematic configuration of a pixel of a solid-state imaging device according to one or more embodiments;

FIG. 3 is a diagram for describing operations of a pixel of a solid-state imaging device;

FIG. 4 is a diagram for describing an effect of a solid-state imaging device;

FIG. 5 is a diagram for describing an effect of a solid-state imaging device including a general column analog-to-digital converter (ADC);

FIG. 6 is a diagram illustrating a schematic configuration of a solid-state imaging device including a general column ADC;

FIG. 7 is a circuit diagram illustrating a schematic configuration of a solid-state imaging device according to one or more embodiments;

FIG. 8 is a diagram for describing operations of a pixel of a solid-state imaging device;

FIG. 9 is a circuit diagram illustrating a schematic configuration of a solid-state imaging device according to one or more embodiments;

FIG. 10 is a diagram for describing operations of a pixel of a solid-state imaging device;

FIG. 11 is a circuit diagram illustrating a schematic configuration of a solid-state imaging device according to one or more embodiments;

FIG. 12 is a diagram illustrating a schematic configuration of a solid-state imaging device according to one or more embodiments;

FIG. 13 is a diagram illustrating a schematic configuration of a solid-state imaging device according to one or more embodiments;

FIG. 14 is a diagram illustrating a schematic configuration of a solid-state imaging device according to one or more embodiments;

FIG. 15 is a diagram illustrating a schematic configuration of a solid-state imaging device according to one or more embodiments;

FIG. 16 is a diagram illustrating a schematic configuration of a solid-state imaging device according to one or more embodiments;

FIG. 17 is a circuit diagram illustrating a schematic configuration of a solid-state imaging device according to one or more embodiments;

FIG. 18 is a diagram illustrating a schematic configuration of a solid-state imaging device according to one or more embodiments; and

FIG. 19 is a diagram illustrating a schematic configuration of a solid-state imaging device according to one or more embodiments.

### DETAILED DESCRIPTION

Hereinafter, embodiments will be described in detail with reference to the accompanying drawings. In the drawings, like reference numeral refers to like element, and a size of each element is illustrated at a ratio differing from one or more embodiments, for clarity and convenience of description. One or more embodiments described below is merely one or more embodiments, and various modifications may be implemented from the embodiment.

Hereinafter, being described as “on” or “over” may include being on not to contact as well as being just on to contact. Likewise, being described as “under” or “below” may include being under not to contact as well as being just under to contact.

A singular form of elements may include a plural form unless another case is clearly designated in context. Also, when an arbitrary portion includes or has an arbitrary element, this may denote further including another element instead of excluding another element, unless oppositely described.

An order may be clearly described on operations configuring a method, or unless oppositely described, the operations may be performed in an appropriate order. The inventive concept is not limited to the description order of the operations. The use of all examples or terms may be merely for describing the inventive concept, and unless defined by claims, the spirit scope is not limited by the examples or the terms.

In the following description, in a case where description is given with ordinal numerals such as “first” and “second,” and unless specially described, the ordinal numerals are used for convenience and do not define an arbitrary order.

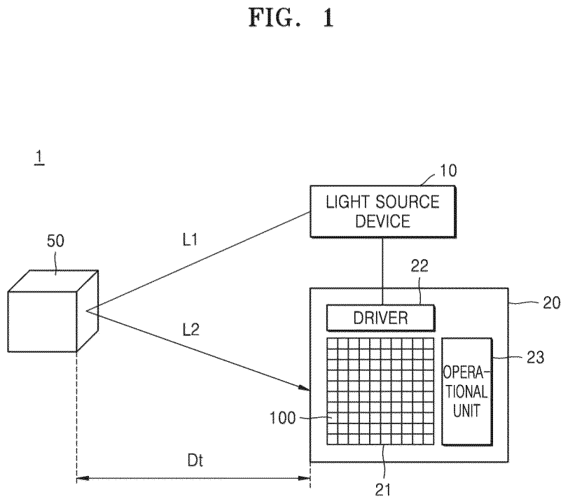

Hereinafter, a solid-state imaging device according to one or more embodiments will be described with reference to FIGS. 1 to 6. FIG. 1 is a diagram illustrating a schematic configuration of a time of flight (TOF) system 1 to which a solid-state imaging device 20 according to one or more embodiments is applied. As illustrated in FIG. 1, the TOF system 1 may include a light source device 10 and a solid-state imaging device 20.

The light source device 10 may irradiate (emit) light L1 onto a subject 50. The light source device 10 may be, for example, a semiconductor laser and may irradiate (emit) a pulse light of a near-infrared wavelength band onto the subject 50. The light source device 10 may include an optical device.

The solid-state imaging device 20 may receive reflected light L2 from the subject 50 to measure a distance Dt to the subject 50. The solid-state imaging device 20 may include a pixel array 21, a driver 22, and an operational unit 23. The pixel array 21 may include a plurality of pixels 100 which are arranged in an array form. Each of the plurality of pixels 100 may receive reflected light of the pulse light reflected by the subject 50 and may output a pixel signal based on the received reflected light. The driver 22 may be driven in synchronization with the light source device 10 and may control an operation of a transistor included in the pixel 100. The operational unit 23 may calculate (obtain) the distance Dt to the subject 50 from the pixel signal. The solid-state imaging device 20 may include an optical device. Also, in FIG. 1, the operational unit 23 may be installed in the solid-state imaging device 20, but is not limited thereto, and may be installed outside the solid-state imaging device 20, for example, installed in an image signal processor (ISP).

The operational unit 23 may include an application specific integrated circuit (ASIC), a field-programmable gate array (FPGA), a dedicated microprocessor, a microprocessor, a general purpose processor, or the like.

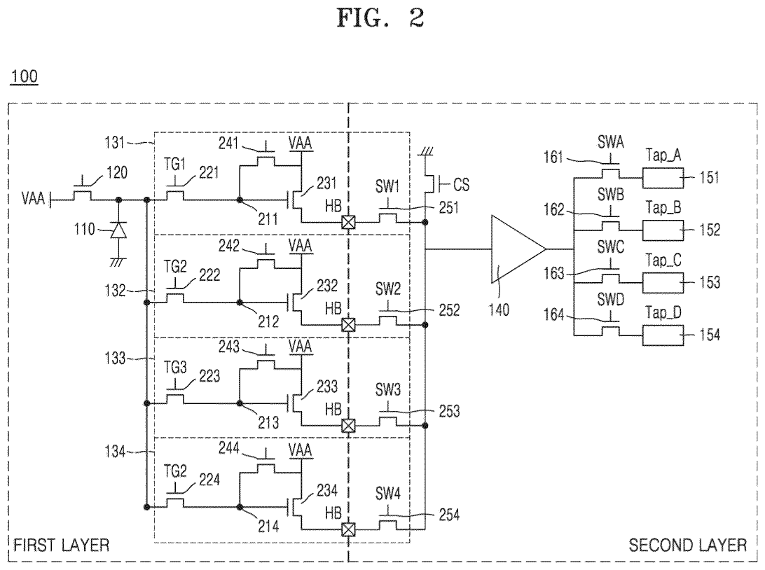

The pixel 100 of the solid-state imaging device 20 will be described below with reference to FIG. 2. FIG. 2 is a circuit diagram illustrating a schematic configuration of the pixel 100 of the solid-state imaging device 20. The pixel 100 according to one or more embodiments may include four tap A Tap_A, tap B Tap_B, tap C Tap_C, and tap D Tap_D.

As illustrated in FIG. 2, the pixel 100 may include a photodiode (PD) 110, a charge discharge transistor 120, a first signal generator 131, a second signal generator 132, a third signal generator 133, and a fourth signal generator 134, an analog-to-digital converter (ADC) integrator 140, a first memory 151, a second memory 152, a third memory 153, and a fourth memory 154, and a first memory selection transistor 161, a second memory selection transistor 162, a third memory selection transistor 163, and a fourth memory selection transistor 164.

The PD 110 may be a photoelectric conversion unit and may photoelectric-convert incident light to generate an electric charge. The charge discharge transistor 120 may perform control to discharge electric charges accumulated in the PD 110. The first to fourth signal generators 131 to 134 may output a voltage having a level based on the amount of electric charges generated by the PD 110. The ADC integrator 140 may be configured with a converter and an adder which are provided as one body, and the ADC integrator 140 may operate as the converter and may convert a voltage, output from each of the first to fourth signal generators 131 to 134, into a digital value. Also, the ADC integrator 140 may operate as the adder and may add the digital value to a digital value previously maintained (stored) in each of the first to fourth memories 151 to 154. Each of the first to fourth memories 151 to 154 may maintain the digital value. The first to fourth memory selection transistors 161 to 164 may switch the first to fourth memories 151 to 154 connected to the ADC integrator 140. The first to fourth memories 151 to 154 may respectively correspond to tap A Tap_A to tap D Tap_D.

The first to fourth signal generators 131 to 134 may respectively include a first floating diffusion (FD) 211, a second floating diffusion (FD) 212, a third floating diffusion (FD) 213, and a fourth floating diffusion (FD) 214, a first transfer transistor 221, a second transfer transistor 222, a third transfer transistor 223, and a fourth transfer transistor 224, a first source follower (SF) transistor 231, a second source follower (SF) transistor 232, a third source follower (SF) transistor 233, and a fourth source follower (SF) transistor 234, a first reset transistor 241, a second reset transistor 242, a third reset transistor 243, and a fourth reset transistor 244, and a first selection transistor 251, a second selection transistor 252, a third selection transistor 253, and a fourth signal selection transistor 254.

Each of the first to fourth FDs 211 to 214 may operate as a charge accumulator and may accumulate an electric charge generated by the PD 110. The first to fourth transfer transistors 221 to 224 may each operate as a transfer controller and may control the transfer of electric charges to the first to fourth FDs 211 to 214 from the PD 110. The first to fourth SF transistors 231 to 234 may output a voltage having a level based on the amount of electric charges accumulated in each of the first to fourth FDs 211 to 214. The first to fourth reset transistors 241 to 244 may perform control to reset electric charges of the first to fourth FDs 211 to 214. The first to fourth signal selection transistors 251 to 254 may switch four SF transistors 231 to 234 connected to the ADC integrator 140.

The pixel 100 according to one or more embodiments may be a pixel of a two-layer structure, and the PD 110, the charge discharge transistor 120, and the first to fourth signal generators 131 to 134 (except the first to fourth signal selection transistors 251 to 254) may be disposed in a first layer. The first to fourth signal selection transistors 251 to 254, the ADC integrator 140, the first to fourth memories 151 to 154, and the first to fourth memory selection transistors 161 to 164 may be disposed in a second layer.

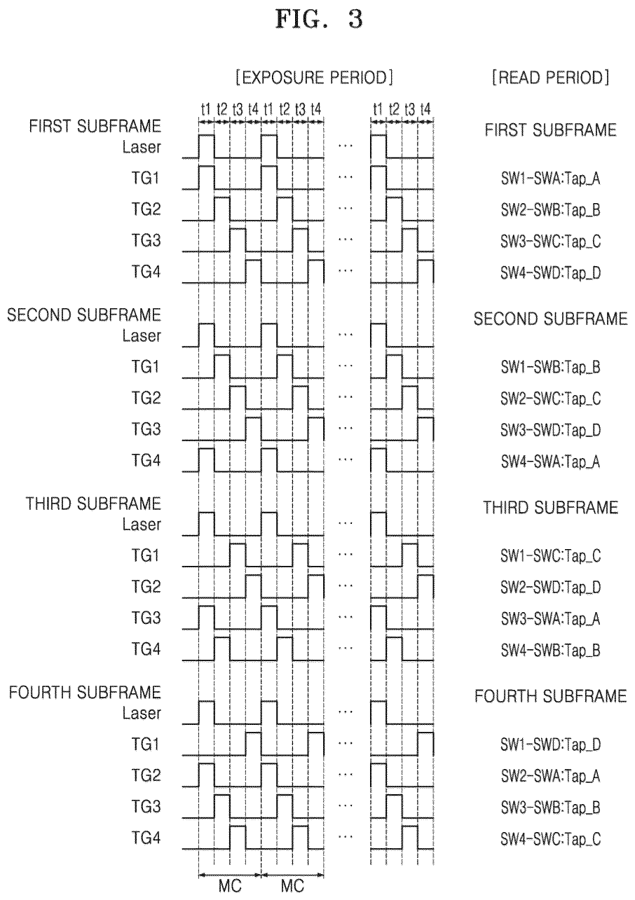

In the pixel 100 according to one or more embodiments, the electric charge generated by the PD 110 may be accumulated in the first to fourth FDs 211 to 214. The ADC integrator 140 may generate a digital value (for example, 0 to 127) based on the amount of electric charges accumulated in the first to fourth FDs 211 to 214 and may add the generated digital value to a digital value which is previously maintained (stored) in each of the first to fourth memories 151 to 154. Hereinafter, an operation of the solid-state imaging device 10 will be described in detail with reference to FIG. 3.

Referring to FIGS. 1, 2, and 3, FIG. 3 is a diagram for describing an operation of the pixel 100 of the solid-state imaging device 20. Hereinafter, a case where one frame is configured with four subframes will be described for example. Each subframe may include an exposure period and a read period. In FIG. 3, laser may represent a driving signal of the light source device 10, and TG1, TG2, TG3, and TG4 may respectively represent driving signals of the first to fourth transfer transistors 221 to 224. SW1, SW2, SW3, and SW4 may respectively represent driving signals of the first to fourth signal selection transistors 251 to 254, and SWA, SWB, SWC, and SWD may respectively represent driving signals of the first to fourth memory selection transistors 161 to 164.

In an exposure period of a first subframe, the light source device 10 may be turned on at a first phase timing t1 and may emit light. Also, the first transfer transistor 221 may be turned on at the first phase timing t1, and the electric charge generated by the PD 110 may be accumulated in the first FD 211 (a first exposure operation).

Subsequently, the second transfer transistor 222 may be turned on at a second phase timing t2, and the electric charge generated by the PD 110 may be accumulated in the second FD 212 (a second exposure operation).

Subsequently, the third transfer transistor 223 may be turned on at a third phase timing t3, and the electric charge generated by the PD 110 may be accumulated in the third FD 213 (a third exposure operation).

Subsequently, the fourth transfer transistor 224 may be turned on at a fourth phase timing t4, and the electric charge generated by the PD 110 may be accumulated in the fourth FD 214 (a fourth exposure operation).

In the exposure period of the first subframe, the first to fourth exposure operations may be included in one operation cycle MC, and the operation cycle MC may be repeated a plurality of times.

In a read period of the first subframe, the first signal selection transistor 251 and the first memory selection transistor 161 may be turned on (a first read operation: Tap_A). Therefore, a digital value based on the amount of electric charges accumulated in the first FD 211 may be generated, and the generated digital value may be added to a digital value which is maintained (stored) in the first memory 151.

Also, the second signal selection transistor 252 and the second memory selection transistor 162 may be turned on (a second read operation: Tap_B). Therefore, a digital value based on the amount of electric charges accumulated in the second FD 212 may be generated, and the generated digital value may be added to a digital value which is maintained (stored) in the second memory 152.

Also, the third signal selection transistor 253 and the third memory selection transistor 163 may be turned on (a third read operation: Tap_C). Therefore, a digital value based on the amount of electric charges accumulated in the third FD 213 may be generated, and the generated digital value may be added to a digital value which is maintained (stored) in the third memory 153.

Also, the fourth signal selection transistor 254 and the fourth memory selection transistor 164 may be turned on (a fourth read operation: Tap_D). Therefore, a digital value based on the amount of electric charges accumulated in the fourth FD 214 may be generated, and the generated digital value may be added to a digital value which is maintained (stored) in the fourth memory 154.

The order of the first to fourth read operations may be changed in the read period of the first subframe. In an exposure period of the second subframe, the fourth transfer transistor 224 may be turned on at the first phase timing t1 at which the light source device 10 is turned on, and the electric charge generated by the PD 110 may be accumulated in the fourth FD 214 (a first exposure operation).

Subsequently, the first transfer transistor 221 may be turned on at the second phase timing t2, and the electric charge generated by the PD 110 may be accumulated in the first FD 211 (a second exposure operation).

Subsequently, the second transfer transistor 222 may be turned on at the third phase timing t3, and the electric charge generated by the PD 110 may be accumulated in the second FD 212 (a third exposure operation).

Subsequently, the third transfer transistor 223 may be turned on at a fourth phase timing t4, and the electric charge generated by the PD 110 may be accumulated in the third FD 213 (a fourth exposure operation).

In the exposure period of the second subframe, the first to fourth exposure operations may configure one operation cycle MC, and the operation cycle MC may be repeated a plurality of times.

In a read period of the second subframe, the fourth signal selection transistor 254 and the first memory selection transistor 161 may be turned on (a first read operation: Tap_A). Therefore, a digital value based on the amount of electric charges accumulated in the fourth FD 214 may be generated, and the generated digital value may be added to a digital value which is maintained (stored) in the first memory 151.

Also, the first signal selection transistor 251 and the second memory selection transistor 162 may be turned on (a second read operation: Tap_B). Therefore, a digital value based on the amount of electric charges accumulated in the first FD 211 may be generated, and the generated digital value may be added to a digital value which is maintained (stored) in the second memory 152.

Also, the second signal selection transistor 252 and the third memory selection transistor 163 may be turned on (a third read operation: Tap_C). Therefore, a digital value based on the amount of electric charges accumulated in the second FD 212 may be generated, and the generated digital value may be added to a digital value which is maintained (stored) in the third memory 153.

Also, the third signal selection transistor 253 and the fourth memory selection transistor 164 may be turned on (a fourth read operation: Tap_D). Therefore, a digital value based on the amount of electric charges accumulated in the third FD 213 may be generated, and the generated digital value may be added to a digital value which is maintained (stored) in the fourth memory 154.

The order of the first to fourth read operations may be changed in the read period of the second subframe.

In an exposure period of the third subframe, the third transfer transistor 223 may be turned on at the first phase timing t1 at which the light source device 10 is turned on, and the electric charge generated by the PD 110 may be accumulated in the third FD 213 (a first exposure operation).

Subsequently, the fourth transfer transistor 224 may be turned on at the second phase timing t2, and the electric charge generated by the PD 110 may be accumulated in the fourth FD 214 (a second exposure operation).

Subsequently, the first transfer transistor 221 may be turned on at the third phase timing t3, and the electric charge generated by the PD 110 may be accumulated in the first FD 211 (a third exposure operation).

Subsequently, the second transfer transistor 222 may be turned on at the fourth phase timing t4, and the electric charge generated by the PD 110 may be accumulated in the second FD 212 (a fourth exposure operation).

In the exposure period of the third subframe, the first to fourth exposure operations may configure one operation cycle MC, and the operation cycle MC may be repeated a plurality of times.

In a read period of the third subframe, the third signal selection transistor 253 and the first memory selection transistor 161 may be turned on (a first read operation: Tap_A). Therefore, a digital value based on the amount of electric charges accumulated in the third FD 213 may be generated, and the generated digital value may be added to a digital value which is maintained (stored) in the first memory 151.

Also, the fourth signal selection transistor 254 and the second memory selection transistor 162 may be turned on (a second read operation: Tap_B). Therefore, a digital value based on the amount of electric charges accumulated in the fourth FD 214 may be generated, and the generated digital value may be added to a digital value which is maintained (stored) in the second memory 152.

Also, the first signal selection transistor 251 and the third memory selection transistor 163 may be turned on (a third read operation: Tap_C). Therefore, a digital value based on the amount of electric charges accumulated in the first FD 211 may be generated, and the generated digital value may be added to a digital value which is maintained (stored) in the third memory 153.

Also, the second signal selection transistor 252 and the fourth memory selection transistor 164 may be turned on (a fourth read operation: Tap_D). Therefore, a digital value based on the amount of electric charges accumulated in the second FD 212 may be generated, and the generated digital value may be added to a digital value which is maintained (stored) in the fourth memory 154.

The order of the first to fourth read operations may be changed in the read period of the third subframe.

In an exposure period of the fourth subframe, the second transfer transistor 222 may be turned on at the first phase timing t1 at which the light source device 10 is turned on, and the electric charge generated by the PD 110 may be accumulated in the second FD 212 (a first exposure operation).

Subsequently, the third transfer transistor 223 may be turned on at the second phase timing t2, and the electric charge generated by the PD 110 may be accumulated in the third FD 213 (a second exposure operation).

Subsequently, the fourth transfer transistor 224 may be turned on at the third phase timing t3, and the electric charge generated by the PD 110 may be accumulated in the fourth FD 214 (a third exposure operation).

Subsequently, the first transfer transistor 221 may be turned on at the fourth phase timing t4, and the electric charge generated by the PD 110 may be accumulated in the first FD 211 (a fourth exposure operation).

In the exposure period of the fourth subframe, the first to fourth exposure operations may configure one operation cycle MC, and the operation cycle MC may be repeated a plurality of times.

In a read period of the fourth subframe, the second signal selection transistor 252 and the first memory selection transistor 161 may be turned on (a first read operation: Tap_A). Therefore, a digital value based on the amount of electric charges accumulated in the second FD 212 may be generated, and the generated digital value may be added to a digital value which is maintained (stored) in the first memory 151.

Also, the third signal selection transistor 253 and the second memory selection transistor 162 may be turned on (a second read operation: Tap_B). Therefore, a digital value based on the amount of electric charges accumulated in the third FD 213 may be generated, and the generated digital value may be added to a digital value which is maintained (stored) in the second memory 152.

Also, the fourth signal selection transistor 254 and the third memory selection transistor 163 may be turned on (a third read operation: Tap_C). Therefore, a digital value based on the amount of electric charges accumulated in the fourth FD 214 may be generated, and the generated digital value may be added to a digital value which is maintained (stored) in the third memory 153.

Also, the first signal selection transistor 251 and the fourth memory selection transistor 164 may be turned on (a fourth read operation: Tap_D). Therefore, a digital value based on the amount of electric charges accumulated in the first FD 211 may be generated, and the generated digital value may be added to a digital value which is maintained (stored) in the fourth memory 154.

The order of the first to fourth read operations may be changed in the read period of the fourth subframe.

As described above, in the solid-state imaging device 20 according to one or more embodiments, the amount of electric charges accumulated in the four FDs 211 to 214 may be converted into and output as a digital value in each subframe. Also, a digital value representing the amount of electric charges of the four FDs 211 to 214 in four continuous subframes may be added to a digital value maintained (stored) in each of different memories 151 to 154 for each subframe.

For example, a digital value representing the amount of electric charges of the first FD 211 in the first subframe may be added to the first memory 151 Tap_A, and a digital value representing the amount of electric charges of the fourth FD 214 in the second subframe may be added to the first memory 151 Tap_A. Also, a digital value representing the amount of electric charges of the third FD 213 in the third subframe may be added, and a digital value representing the amount of electric charges of the second FD 212 in the fourth subframe may be added. As a result, a sum (summed value) of four digital values based on the amount of electric charges of four different FDs 211 to 214 may be maintained (stored) in the first memory 151. Also, the four digital values may represent the amount of electric charges accumulated in the FDs 211 to 214 at the same phase timing (a first phase timing) in each subframe.

Similarly, a digital value representing the amount of electric charges of the second FD 212 in the first subframe may be added to the second memory 152 Tap_B, and a digital value representing the amount of electric charges of the first FD 211 in the second subframe may be added to the second memory 152 Tap_B. Also, a digital value representing the amount of electric charges of the fourth FD 214 in the third subframe may be added, and a digital value representing the amount of electric charges of the third FD 213 in the fourth subframe may be added. As a result, a sum (summed value) of four digital values based on the amount of electric charges of the four different FDs 211 to 214 may be maintained (stored) in the second memory 152. Also, the four digital values may represent the amount of electric charges accumulated in the FDs 211 to 214 at the same phase timing (a second phase timing) in each subframe. The third memory 153 and the fourth memory 154 may be as described above.

Based on such a configuration, the non-uniformity of characteristics of the four FDs 211 to 214 in the tap A Tap_A to tap D Tap_D may be averaged, and thus, the non-uniformity between taps may be canceled. Accordingly, in the solid-state imaging device 20 according to one or more embodiments, a distance to a subject may be measured with improved precision.

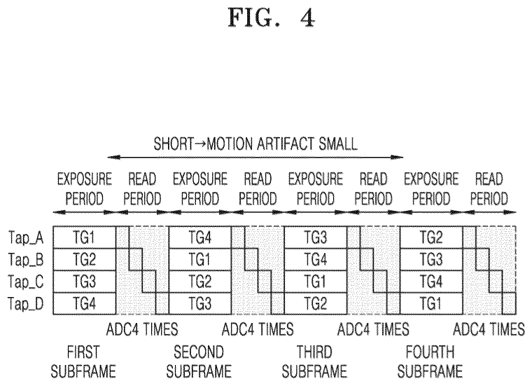

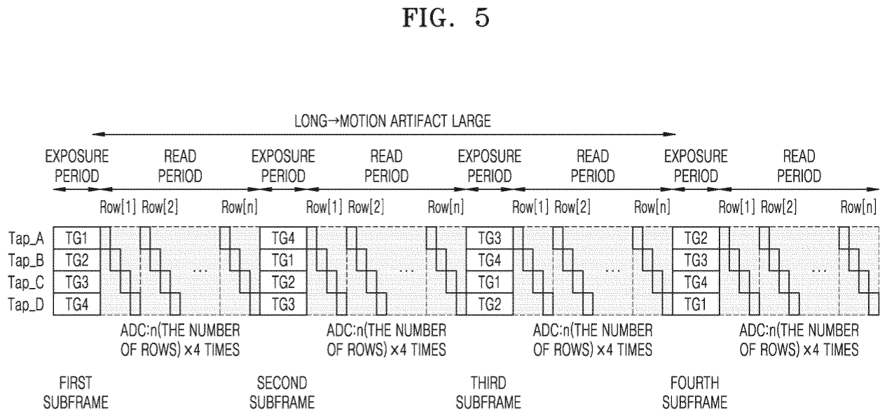

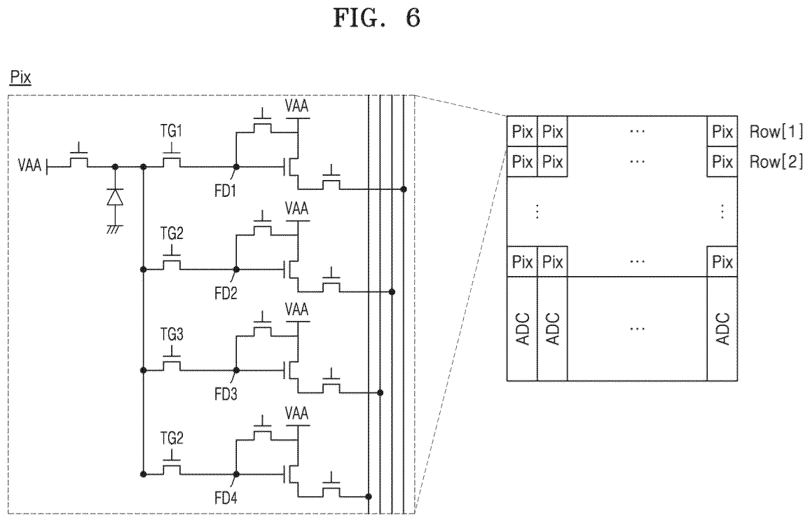

Hereinafter, an effect of the solid-state imaging device 20 will be described in more detail with reference to FIGS. 4 to 6. FIG. 4 is a diagram for describing an effect of a solid-state imaging device 20 according to one or more embodiments. FIG. 5 is a diagram illustrating, as a related example, an effect of a solid-state imaging device including a general column ADC. FIG. 6 is a diagram illustrating a solid-state imaging device including a general column ADC.

As illustrated in FIG. 5, in a solid-state imaging device according to a related example, four transfer transistors which control the transfer of an electric charge to four FDs 1 to 4 may be turned on in the order of TG1→TG2→TG3→TG4, which may always be constant. Due to this, in a general solid-state imaging device, one FD may be allocated to one tap, and non-uniformity between taps causing the non-uniformity of characteristics of the FDs 1 to 4 may occur. As a result, a problem where the precision of measurement is reduced may occur in the general solid-state imaging device. Additionally, in the solid-state imaging device according to the comparative example, because a pixel signal of an nth row is read by pixel row units for each subframe, a read time may increase, and due to this, a motion artifact may occur.

In the solid-state imaging device according to one or more embodiments, four transfer transistors 221 to 224 which control the transfer of an electric charge to four FDs 211 to 214 may be turned on in different orders for each subframe. A sum (summed value) of digital values based on the amount of electric charges accumulated in four different FDs 211 to 214 may be maintained (stored) in the memories 151 to 154 corresponding to each tap, and the non-uniformity of characteristics of the four FDs 211 to 214 may be averaged. Accordingly, in the solid-state imaging device according to one or more embodiments, non-uniformity between taps may be canceled, and a distance to a subject may be measured with improved precision. Furthermore, in the solid-state imaging device according to one or more embodiments, because a pixel signal is read by pixel units by the memories 151 to 154 installed in the pixel 100, a read time may be shortened, and thus, the occurrence of a motion artifact may be prevented.

In the solid-state imaging device according to one or more embodiments, the amount of electric charges accumulated in the four FDs 211 to 214 may be converted into a digital value and added, and thus, a memory area may be reduced. Also, in the solid-state imaging device according to one or more embodiments, a period of each subframe may be reduced, and thus, a saturation of a pixel signal caused by background light may be prevented.

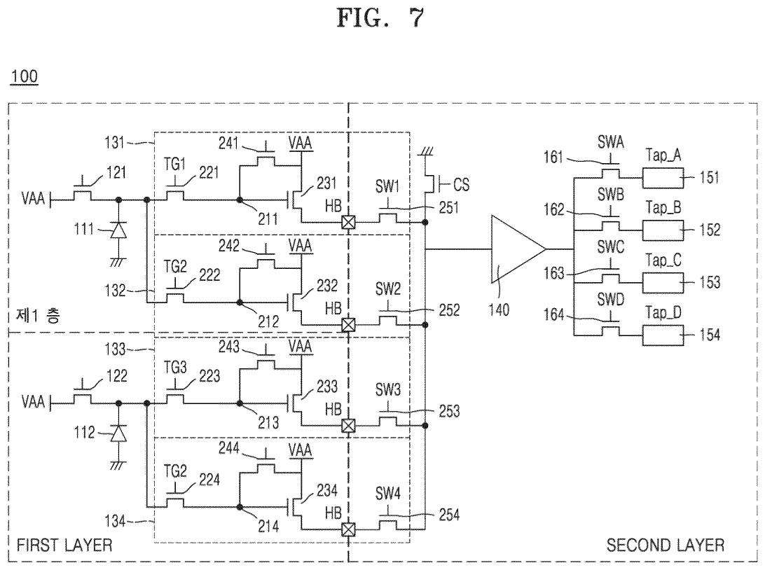

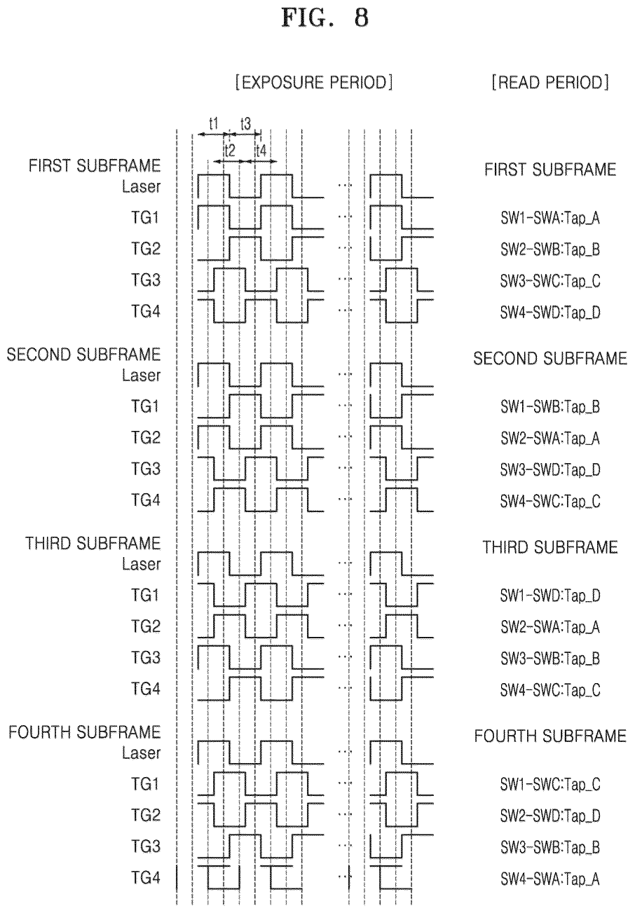

Hereinafter, a solid-state imaging device according to one or more embodiments will be described with reference to FIGS. 7 and 8. In the solid-state imaging device according to one or more embodiments, a pixel may include two PDs. In FIG. 2, like reference numerals refer to like elements, and their descriptions are omitted.

FIG. 7 is a circuit diagram illustrating a schematic configuration of a pixel 100 of a solid-state imaging device 20 according to one or more embodiments. As illustrated in FIG. 7, the pixel 100 may include a first PD 111 and a second PD 112, a first charge discharge transistor 121 and a second charge discharge transistor 122, first to fourth signal generators 131 to 134, an ADC integrator 140, first to fourth memories 151 to 154, and first to fourth memory selection transistors 161 to 164. The first and second signal generators 131 and 132 may be connected to the first PD 111, and the third and fourth signal generators 133 and 134 may be connected to the second PD 112.

FIG. 8 is a diagram for describing an operation of the pixel 100 of the solid-state imaging device 20. In one or more embodiments, one frame may be configured with four subframes, and each of the subframes may include an exposure period and a read period. A pulse signal representing a phase timing may be delayed by a half pulse and may then be input.

In an exposure period of a first subframe, the first transfer transistor 221 may be turned on at a first phase timing t1 at which the light source device 10 is turned on, and an electric charge generated by the first PD 111 may be accumulated in the first FD 211 (a first exposure operation).

Subsequently, the third transfer transistor 223 may be turned on at a second phase timing t2, and an electric charge generated by the second PD 112 may be accumulated in the third FD 213 (a second exposure operation).

Subsequently, the second transfer transistor 222 may be turned on at a third phase timing t3, and the electric charge generated by the first PD 111 may be accumulated in the second FD 212 (a third exposure operation).

Subsequently, the fourth transfer transistor 224 may be turned on at a fourth phase timing t4, and the electric charge generated by the second PD 112 may be accumulated in the fourth FD 214 (a fourth exposure operation).

In the exposure period of the first subframe, the first to fourth exposure operations may configure one operation cycle, and the operation cycle may be repeated a plurality of times.

In a read period of the first subframe, the first signal selection transistor 251 and the first memory selection transistor 161 may be turned on (a first read operation: Tap_A). Therefore, a digital value based on the amount of electric charges accumulated in the first FD 211 may be generated, and the generated digital value may be added to a digital value which is maintained (stored) in the first memory 151.

Also, the second signal selection transistor 252 and the second memory selection transistor 162 may be turned on (a second read operation: Tap_B). Therefore, a digital value based on the amount of electric charges accumulated in the second FD 212 may be generated, and the generated digital value may be added to a digital value which is maintained (stored) in the second memory 152.

Also, the third signal selection transistor 253 and the third memory selection transistor 163 may be turned on (a third read operation: Tap_C). Therefore, a digital value based on the amount of electric charges accumulated in the third FD 213 may be generated, and the generated digital value may be added to a digital value which is maintained (stored) in the third memory 153.

Also, the fourth signal selection transistor 254 and the fourth memory selection transistor 164 may be turned on (a fourth read operation: Tap_D). Therefore, a digital value based on the amount of electric charges accumulated in the fourth FD 214 may be generated, and the generated digital value may be added to a digital value which is maintained (stored) in the fourth memory 154.

The order of the first to fourth read operations may be changed in the read period of the first subframe.

In an exposure period of the second subframe, the second transfer transistor 222 may be turned on at the first phase timing t1 at which the light source device 10 is turned on, and the electric charge generated by the first PD 111 may be accumulated in the second FD 212 (a first exposure operation).

Subsequently, the fourth transfer transistor 224 may be turned on at a second phase timing t2, and the electric charge generated by the second PD 112 may be accumulated in the fourth FD 214 (a second exposure operation).

Subsequently, the first transfer transistor 221 may be turned on at the third phase timing t3, and the electric charge generated by the first PD 111 may be accumulated in the first FD 211 (a third exposure operation).

Subsequently, the third transfer transistor 223 may be turned on at a fourth phase timing t4, and an electric charge generated by the second PD 112 may be accumulated in the third FD 213 (a fourth exposure operation).

In the exposure period of the second subframe, the first to fourth exposure operations may configure one operation cycle, and the operation cycle may be repeated a plurality of times.

In a read period of the second subframe, the second signal selection transistor 252 and the first memory selection transistor 161 may be turned on (a first read operation: Tap_A). Therefore, a digital value based on the amount of electric charges accumulated in the second FD 212 may be generated, and the generated digital value may be added to a digital value which is maintained (stored) in the first memory 151.

Also, the first signal selection transistor 251 and the second memory selection transistor 162 may be turned on (a second read operation: Tap_B). Therefore, a digital value based on the amount of electric charges accumulated in the first FD 211 may be generated, and the generated digital value may be added to a digital value which is maintained (stored) in the second memory 152.

Also, the fourth signal selection transistor 254 and the third memory selection transistor 163 may be turned on (a third read operation: Tap_C). Therefore, a digital value based on the amount of electric charges accumulated in the fourth FD 214 may be generated, and the generated digital value may be added to a digital value which is maintained (stored) in the third memory 153.

Also, the third signal selection transistor 253 and the fourth memory selection transistor 164 may be turned on (a fourth read operation: Tap_D). Therefore, a digital value based on the amount of electric charges accumulated in the third FD 213 may be generated, and the generated digital value may be added to a digital value which is maintained (stored) in the fourth memory 154.

The order of the first to fourth read operations may be changed in the read period of the second subframe.

In an exposure period of the third subframe, the third transfer transistor 223 may be turned on at the first phase timing t1 at which the light source device 10 is turned on, and the electric charge generated by the second PD 112 may be accumulated in the third FD 213 (a first exposure operation).

Subsequently, the second transfer transistor 222 may be turned on at a second phase timing t2, and the electric charge generated by the first PD 111 may be accumulated in the second FD 212 (a second exposure operation).

Subsequently, the fourth transfer transistor 224 may be turned on at a third phase timing t3, and the electric charge generated by the second PD 112 may be accumulated in the fourth FD 214 (a third exposure operation).

Subsequently, the first transfer transistor 221 may be turned on at the fourth phase timing t4, and the electric charge generated by the first PD 111 may be accumulated in the first FD 211 (a fourth exposure operation).

In the exposure period of the third subframe, the first to fourth exposure operations may configure one operation cycle, and the operation cycle may be repeated a plurality of times.

In a read period of the third subframe, the third signal selection transistor 253 and the first memory selection transistor 161 may be turned on (a first read operation: Tap_A). Therefore, a digital value based on the amount of electric charges accumulated in the third FD 213 may be generated, and the generated digital value may be added to a digital value which is maintained (stored) in the first memory 151.

Also, the fourth signal selection transistor 254 and the second memory selection transistor 162 may be turned on (a second read operation: Tap_B). Therefore, a digital value based on the amount of electric charges accumulated in the fourth FD 214 may be generated, and the generated digital value may be added to a digital value which is maintained (stored) in the second memory 152.

Also, the second signal selection transistor 252 and the third memory selection transistor 163 may be turned on (a third read operation: Tap_C). Therefore, a digital value based on the amount of electric charges accumulated in the second FD 212 may be generated, and the generated digital value may be added to a digital value which is maintained (stored) in the third memory 153.

Also, the first signal selection transistor 251 and the fourth memory selection transistor 164 may be turned on (a fourth read operation: Tap_D). Therefore, a digital value based on the amount of electric charges accumulated in the first FD 211 may be generated, and the generated digital value may be added to a digital value which is maintained (stored) in the fourth memory 154.

The order of the first to fourth read operations may be changed in the read period of the third subframe.

In an exposure period of the fourth subframe, the fourth transfer transistor 224 may be turned on at the first phase timing t1 at which the light source device 10 is turned on, and the electric charge generated by the second PD 112 may be accumulated in the fourth FD 214 (a first exposure operation).

Subsequently, the first transfer transistor 221 may be turned on at the second phase timing t2, and the electric charge generated by the first PD 111 may be accumulated in the first FD 211 (a second exposure operation).

Subsequently, the third transfer transistor 223 may be turned on at a third phase timing t3, and an electric charge generated by the second PD 112 may be accumulated in the third FD 213 (a third exposure operation).

Subsequently, the second transfer transistor 222 may be turned on at a fourth phase timing t4, and the electric charge generated by the first PD 111 may be accumulated in the second FD 212 (a fourth exposure operation).

In the exposure period of the fourth subframe, the first to fourth exposure operations may configure one operation cycle, and the operation cycle may be repeated a plurality of times.

In a read period of the fourth subframe, the fourth signal selection transistor 254 and the first memory selection transistor 161 may be turned on (a first read operation: Tap_A). Therefore, a digital value based on the amount of electric charges accumulated in the fourth FD 214 may be generated, and the generated digital value may be added to a digital value which is maintained (stored) in the first memory 151.

Also, the third signal selection transistor 253 and the second memory selection transistor 162 may be turned on (a second read operation: Tap_B). Therefore, a digital value based on the amount of electric charges accumulated in the third FD 213 may be generated, and the generated digital value may be added to a digital value which is maintained (stored) in the second memory 152.

Also, the first signal selection transistor 251 and the third memory selection transistor 163 may be turned on (a third read operation: Tap_). Therefore, a digital value based on the amount of electric charges accumulated in the first FD 211 may be generated, and the generated digital value may be added to a digital value which is maintained (stored) in the third memory 153.

Also, the second signal selection transistor 252 and the fourth memory selection transistor 164 may be turned on (a fourth read operation: Tap_D). Therefore, a digital value based on the amount of electric charges accumulated in the second FD 212 may be generated, and the generated digital value may be added to a digital value which is maintained (stored) in the fourth memory 154.

The order of the first to fourth read operations may be changed in the read period of the fourth subframe.

As described above, in the solid-state imaging device 20 according to one or more embodiments, the amount of electric charges accumulated in the four FDs 211 to 214 may be converted into and output as a digital value in each subframe. Also, a digital value representing the amount of electric charges of the four FDs 211 to 214 in four continuous subframes may be added to a digital value maintained (stored) in each of different memories 151 to 154 for each subframe. Based on such a configuration, the non-uniformity of characteristics of four FDs 211 to 214 may be averaged, and a distance to a subject may be measured with improved precision.

Furthermore, in the solid-state imaging device according to one or more embodiments, because the pixel 100 is configured with two units each including one PD and two signal generators, a signal generator may be implemented with precision which is higher than when a pixel is configured with one unit including four signal generators.

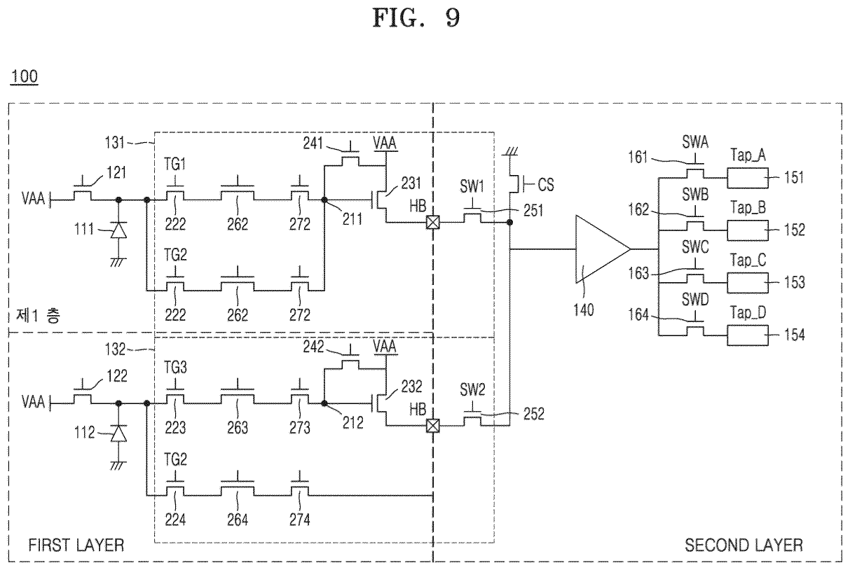

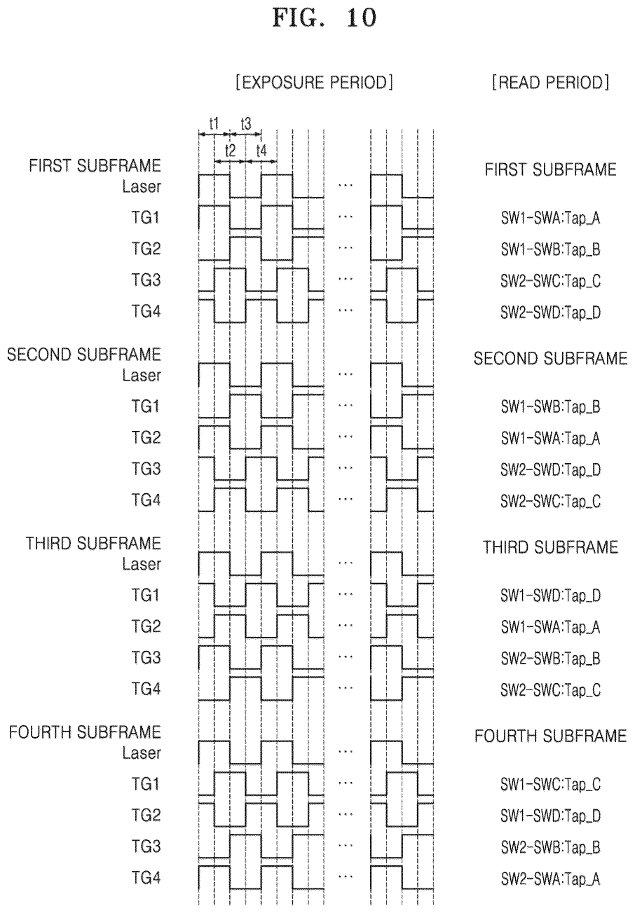

Hereinafter, a solid-state imaging device according to one or more embodiments will be described with reference to FIGS. 9 and 10. In one or more embodiments, an electric charge generated by a PD may be temporarily maintained (stored) a charge memory. In FIGS. 2 and 7, like reference numerals refer to like elements, and their descriptions are omitted.

FIG. 9 is a circuit diagram illustrating a schematic configuration of a pixel 100 of a solid-state imaging device 20 according to one or more embodiments. As illustrated in FIG. 9, the pixel 100 may include first and second PDs 111 and 112, first and second charge discharge transistors 121 and 122, first and second signal generators 131 and 132, an ADC integrator 140, first to fourth memories 151 to 154, and first to fourth memory selection transistors 161 to 164. The first signal generator 131 may be connected to the first PD 111, and the second signal generator 132 may be connected to the second PD 112.

Each of the first and second signal generators 131 and 132 may include first and second FDs 211 and 212, first to fourth transfer transistors 221 to 224, a first charge memory 261, a second charge memory 262, a third charge memory 263, and a fourth charge memory 264, a first memory transistor 271, a second memory transistor 272, a third memory transistor 273, and a fourth memory transistor 274, first and second SF transistors 231 and 232, first and second reset transistors 241 and 242, and first and second signal selection transistors 251 and 252.

The first to fourth charge memories 261 to 264 may be disposed between the first to fourth transfer transistors 221 to 224 and the first and second FDs 211 and 212 and may temporarily maintain (store) electric charges. The first to fourth memory transistors 271 to 274 may be disposed between the first to fourth charge memories 261 to 264 and the first and second FDs 211 and 212 and may control the transfer of electric charges from the first to fourth charge memories 261 to 264.

In the solid-state imaging device 200 according to one or more embodiments configured as described above, electric charges generated by the first and second PDs 111 and 112 may be temporarily maintained (stored) in the first to fourth charge memories 261 to 264. Accordingly, reset noise (KTC noise) which occurs when electric charges of the first and second FDs 211 and 212 may be prevented.

FIG. 10 is a diagram for describing an operation of the pixel 100 of the solid-state imaging device 20. In one or more embodiments, one frame may be configured with four subframes, and each of the subframes may include an exposure period and a read period. A pulse signal representing a phase timing may be delayed by a half pulse and may then be input.

In an exposure period of a first subframe, the first transfer transistor 221 may be turned on at a first phase timing t1 at which the light source device 10 is turned on, and an electric charge generated by the first PD 111 may be maintained (stored) in the first charge memory 261 (a first exposure operation).

Subsequently, the third transfer transistor 223 may be turned on at a second phase timing t2, and an electric charge generated by the second PD 112 may be maintained (stored) in the third charge memory 263 (a second exposure operation).

Subsequently, the second transfer transistor 222 may be turned on at a third phase timing t3, and the electric charge generated by the first PD 111 may be maintained (stored) in the second charge memory 262 (a third exposure operation).

Subsequently, the fourth transfer transistor 224 may be turned on at a fourth phase timing t4, and an electric charge generated by the second PD 112 may be maintained (stored) in the fourth charge memory 264 (a fourth exposure operation).

In the exposure period of the first subframe, the first to fourth exposure operations may configure one operation cycle, and the operation cycle may be repeated a plurality of times.

In a read period of the first subframe, the first signal selection transistor 251 and the first memory selection transistor 161 may be turned on (a first read operation: Tap_A). Also, after the first reset transistor 241 is temporarily turned on, the first memory transistor 271 may be turned on, and thus, an electric charge of the first charge memory 261 may be accumulated in the first FD 211. Also, a digital value based on the amount of accumulated electric charges may be generated, and the generated digital value may be added to a digital value which is maintained (stored) in the first memory 151.

Also, the first signal selection transistor 251 and the second memory selection transistor 162 may be turned on (a second read operation: Tap_B). Also, after the first reset transistor 241 is temporarily turned on, the second memory transistor 272 may be turned on, and thus, an electric charge of the second charge memory 262 may be accumulated in the first FD 211. Also, a digital value based on the amount of accumulated electric charges may be generated, and the generated digital value may be added to a digital value which is maintained (stored) in the second memory 152.

Also, the second signal selection transistor 252 and the third memory selection transistor 163 may be turned on (a third read operation: Tap_C). Also, after the second reset transistor 242 is temporarily turned on, the third memory transistor 273 may be turned on, and thus, an electric charge of the third charge memory 263 may be accumulated in the second FD 212. Also, a digital value based on the amount of accumulated electric charges may be generated, and the generated digital value may be added to a digital value which is maintained (stored) in the third memory 153.

Also, the second signal selection transistor 252 and the fourth memory selection transistor 164 may be turned on (a fourth read operation: Tap_D). Also, after the second reset transistor 242 is temporarily turned on, the fourth memory transistor 274 may be turned on, and thus, an electric charge of the fourth charge memory 264 may be accumulated in the second FD 212. Also, a digital value based on the amount of accumulated electric charges may be generated, and the generated digital value may be added to a digital value which is maintained (stored) in the fourth memory 154.

The order of the first to fourth read operations may be changed in the read period of the first subframe.

In an exposure period of a second subframe, the second transfer transistor 222 may be turned on at a first phase timing t1 at which the light source device 10 is turned on, and an electric charge generated by the first PD 111 may be maintained (stored) in the second charge memory 262 (a first exposure operation).

Subsequently, the fourth transfer transistor 224 may be turned on at a second phase timing t2, and an electric charge generated by the second PD 112 may be maintained (stored) in the fourth charge memory 264 (a second exposure operation).

Subsequently, the first transfer transistor 221 may be turned on at a third phase timing t3, and an electric charge generated by the first PD 111 may be maintained (stored) in the first charge memory 261 (a third exposure operation).

Subsequently, the third transfer transistor 223 may be turned on at a fourth phase timing t4, and an electric charge generated by the second PD 112 may be maintained (stored) in the third charge memory 263 (a fourth exposure operation).

In the exposure period of the second subframe, the first to fourth exposure operations may configure one operation cycle, and the operation cycle may be repeated a plurality of times.

In a read period of the second subframe, the first signal selection transistor 251 and the first memory selection transistor 161 may be turned on (a first read operation: Tap_A). Also, after the first reset transistor 241 is temporarily turned on, the second memory transistor 272 may be turned on, and thus, an electric charge of the second charge memory 262 may be accumulated in the first FD 211. Also, a digital value based on the amount of accumulated electric charges may be generated, and the generated digital value may be added to a digital value which is maintained (stored) in the first memory 151.

Also, the first signal selection transistor 251 and the second memory selection transistor 162 may be turned on (a second read operation: Tap_B). Also, after the first reset transistor 241 is temporarily turned on, the first memory transistor 271 may be turned on, and thus, an electric charge of the first charge memory 261 may be accumulated in the first FD 211. Also, a digital value based on the amount of accumulated electric charges may be generated, and the generated digital value may be added to a digital value which is maintained (stored) in the second memory 152.

Also, the second signal selection transistor 252 and the third memory selection transistor 163 may be turned on (a third read operation: Tap_C). Also, after the second reset transistor 242 is temporarily turned on, the fourth memory transistor 274 may be turned on, and thus, an electric charge of the fourth charge memory 264 may be accumulated in the second FD 212. Also, a digital value based on the amount of accumulated electric charges may be generated, and the generated digital value may be added to a digital value which is maintained (stored) in the third memory 153.

Also, the second signal selection transistor 252 and the fourth memory selection transistor 164 may be turned on (a fourth read operation: Tap_D). Also, after the second reset transistor 242 is temporarily turned on, the third memory transistor 273 may be turned on, and thus, an electric charge of the third charge memory 263 may be accumulated in the second FD 212. Also, a digital value based on the amount of accumulated electric charges may be generated, and the generated digital value may be added to a digital value which is maintained (stored) in the fourth memory 154.

The order of the first to fourth read operations may be changed in the read period of the second subframe.

In an exposure period of a third subframe, the third transfer transistor 223 may be turned on at a first phase timing t1 at which the light source device 10 is turned on, and an electric charge generated by the second PD 112 may be maintained (stored) in the third charge memory 263 (a first exposure operation).

Subsequently, the second transfer transistor 222 may be turned on at a second phase timing t2, and the electric charge generated by the first PD 111 may be maintained (stored) in the second charge memory 262 (a second exposure operation).

Subsequently, the fourth transfer transistor 224 may be turned on at a third phase timing t3, and an electric charge generated by the second PD 112 may be maintained (stored) in the fourth charge memory 264 (a third exposure operation).

Subsequently, the first transfer transistor 221 may be turned on at a fourth phase timing t4, and an electric charge generated by the first PD 111 may be maintained (stored) in the first charge memory 261 (a fourth exposure operation).

In the exposure period of the third subframe, the first to fourth exposure operations may configure one operation cycle, and the operation cycle may be repeated a plurality of times.

In a read period of the third subframe, the second signal selection transistor 252 and the first memory selection transistor 161 may be turned on (a first read operation: Tap_A). Also, after the second reset transistor 242 is temporarily turned on, the third memory transistor 273 may be turned on, and thus, an electric charge of the third charge memory 263 may be accumulated in the second FD 212. Also, a digital value based on the amount of accumulated electric charges may be generated, and the generated digital value may be added to a digital value which is maintained (stored) in the first memory 151.

Also, the second signal selection transistor 252 and the second memory selection transistor 162 may be turned on (a second read operation: Tap_B). Also, after the second reset transistor 242 is temporarily turned on, the fourth memory transistor 274 may be turned on, and thus, an electric charge of the fourth charge memory 264 may be accumulated in the second FD 212. Also, a digital value based on the amount of accumulated electric charges may be generated, and the generated digital value may be added to a digital value which is maintained (stored) in the second memory 152.

Also, the first signal selection transistor 251 and the third memory selection transistor 163 may be turned on (a third read operation: Tap_C). Also, after the first reset transistor 241 is temporarily turned on, the second memory transistor 272 may be turned on, and thus, an electric charge of the second charge memory 262 may be accumulated in the first FD 211. Also, a digital value based on the amount of accumulated electric charges may be generated, and the generated digital value may be added to a digital value which is maintained (stored) in the third memory 153.

Also, the first signal selection transistor 251 and the fourth memory selection transistor 164 may be turned on (a fourth read operation: Tap_D). Also, after the first reset transistor 241 is temporarily turned on, the first memory transistor 271 may be turned on, and thus, an electric charge of the first charge memory 261 may be accumulated in the first FD 211. Also, a digital value based on the amount of accumulated electric charges may be generated, and the generated digital value may be added to a digital value which is maintained (stored) in the fourth memory 154.

The order of the first to fourth read operations may be changed in the read period of the third subframe.

In an exposure period of a third subframe, the fourth transfer transistor 224 may be turned on at a first phase timing t1 at which the light source device 10 is turned on, and an electric charge generated by the second PD 112 may be maintained (stored) in the fourth charge memory 264 (a first exposure operation).

Subsequently, the first transfer transistor 221 may be turned on at a second phase timing t2, and an electric charge generated by the first PD 111 may be maintained (stored) in the first charge memory 261 (a second exposure operation).

Subsequently, the third transfer transistor 223 may be turned on at a third phase timing t3, and an electric charge generated by the second PD 112 may be maintained (stored) in the third charge memory 263 (a third exposure operation).

Subsequently, the second transfer transistor 222 may be turned on at a fourth phase timing t4, and the electric charge generated by the first PD 111 may be maintained (stored) in the second charge memory 262 (a fourth exposure operation).

In the exposure period of the fourth subframe, the first to fourth exposure operations may configure one operation cycle, and the operation cycle may be repeated a plurality of times.

In a read period of the fourth subframe, the second signal selection transistor 252 and the first memory selection transistor 161 may be turned on (a first read operation: Tap_A). Also, after the second reset transistor 242 is temporarily turned on, the fourth memory transistor 274 may be turned on, and thus, an electric charge of the fourth charge memory 264 may be accumulated in the second FD 212. Also, a digital value based on the amount of accumulated electric charges may be generated, and the generated digital value may be added to a digital value which is maintained (stored) in the first memory 151.

Also, the second signal selection transistor 252 and the second memory selection transistor 162 may be turned on (a second read operation: Tap_B). Also, after the second reset transistor 242 is temporarily turned on, the third memory transistor 273 may be turned on, and thus, an electric charge of the third charge memory 263 may be accumulated in the second FD 212. Also, a digital value based on the amount of accumulated electric charges may be generated, and the generated digital value may be added to a digital value which is maintained (stored) in the second memory 152.

Also, the first signal selection transistor 251 and the third memory selection transistor 163 may be turned on (a third read operation: Tap_C). Also, after the first reset transistor 241 is temporarily turned on, the first memory transistor 271 may be turned on, and thus, an electric charge of the first charge memory 261 may be accumulated in the first FD 211. Also, a digital value based on the amount of accumulated electric charges may be generated, and the generated digital value may be added to a digital value which is maintained (stored) in the third memory 153.

Also, the first signal selection transistor 251 and the fourth memory selection transistor 164 may be turned on (a fourth read operation: Tap_D). Also, after the first reset transistor 241 is temporarily turned on, the second memory transistor 272 may be turned on, and thus, an electric charge of the second charge memory 262 may be accumulated in the first FD 211. Also, a digital value based on the amount of accumulated electric charges may be generated, and the generated digital value may be added to a digital value which is maintained (stored) in the fourth memory 154.

The order of the first to fourth read operations may be changed in the read period of the fourth subframe.

As described above, in the solid-state imaging device 20 according to one or more embodiments, the amount of electric charges accumulated in two FDs 211 and 212 may be converted into and output as a digital value in each subframe. Also, a digital value representing the amount of electric charges of the two FDs 211 and 212 in four continuous subframes may be added to a digital value maintained (stored) in each of different memories 151 to 154 for each subframe. Based on such a configuration, the non-uniformity of characteristics of the two FDs 211 and 212 may be averaged, and a distance to a subject may be measured with improved precision.

Furthermore, in the solid-state imaging device 20 according to one or more embodiments, electric charges generated by the first and second PDs 111 and 112 may be temporarily maintained (stored) in the first to fourth charge memories 261 to 264, and a correlation double sampling operation may be executed, and thus, reset noise may be prevented. As a result, a distance to a subject may be measured with improved precision.

In one or more embodiments described above, a case where the pixel 100 includes the two FDs 211 and 212 has been described for example. However, as described above with reference to FIGS. 2 and 7, the pixel 100 may include four FDs 211 to 214. Also, as described above with reference to FIG. 2, the pixel 100 may include one PD 110.

In the pixel described above with reference to FIGS. 2, 7, and 9, an ADC and an adder may be configured integrally as one body. However, an ADC and an adder may be separate and individually configured.

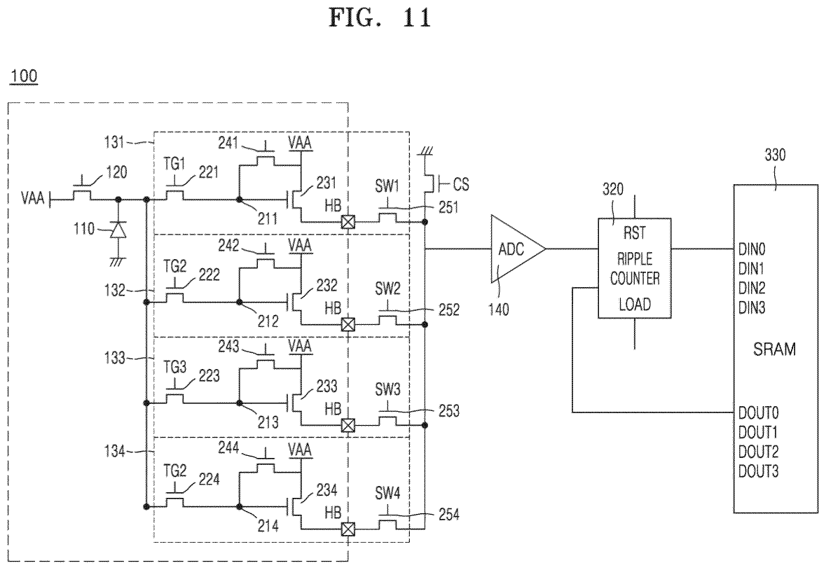

FIG. 11 is a circuit diagram illustrating a schematic configuration of a pixel 100 of a solid-state imaging device 20 according to one or more embodiments. As illustrated in FIG. 11, the pixel 100 may include a PD 110, a charge discharge transistor 120, first to fourth signal generators 131 to 134, an ADC 310, a ripple counter 320, and static random access memory (RAM) (SRAM) 330.

The ADC 310 may operate as a converter and may convert a voltage, output from each of the first to fourth signal generators 131 to 134, into a digital value. Also, the ripple counter 320 may operate as an adder and may add the digital value, obtained by the ADC 310, to a digital value which is previously maintained (stored) in the SRAM 330. The SRAM 330 may be a memory and may maintain (store) a digital value.

In the solid-state imaging device 20 according to one or more embodiments configured as described above, the ripple counter 320 may read a digital value which is maintained (stored) in each of memory areas of the SRAM 330 corresponding to four taps. Also, the ripple counter 320 may add a digital value, output from the ADC 310, to the read digital value and may then maintain (store) an after-addition digital value in the memory area of the SRAM 330.

The SRAM 330 may be connected to a certain number of pixels 100 in common.

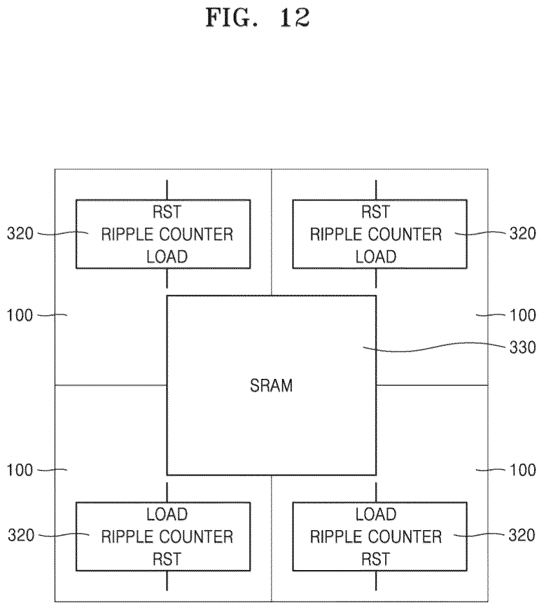

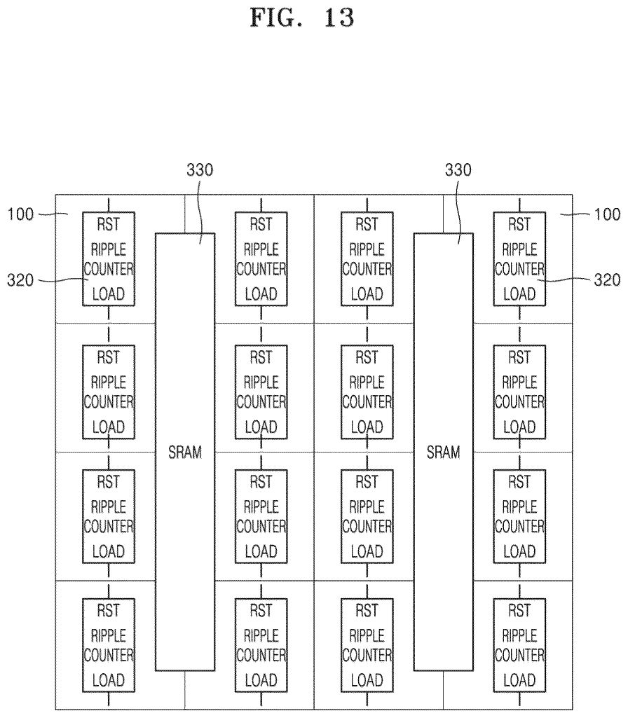

For example, as illustrated in FIG. 12, the SRAM 330 may be connected to four pixels 100 in common. As another example, as illustrated in FIG. 13, the SRAM 330 may be connected to eight pixels 100 in common. Based on such a configuration, a circuit area may be reduced.

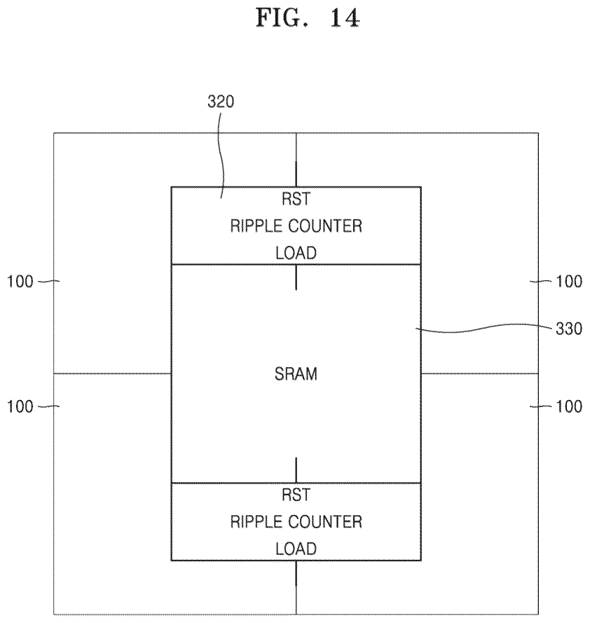

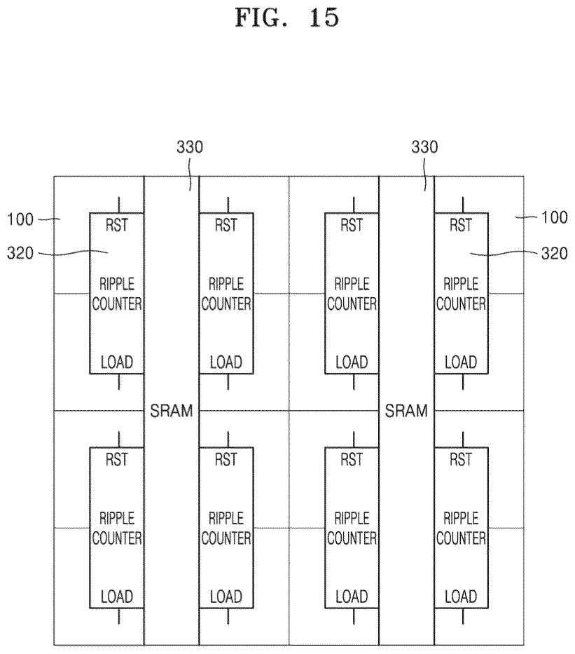

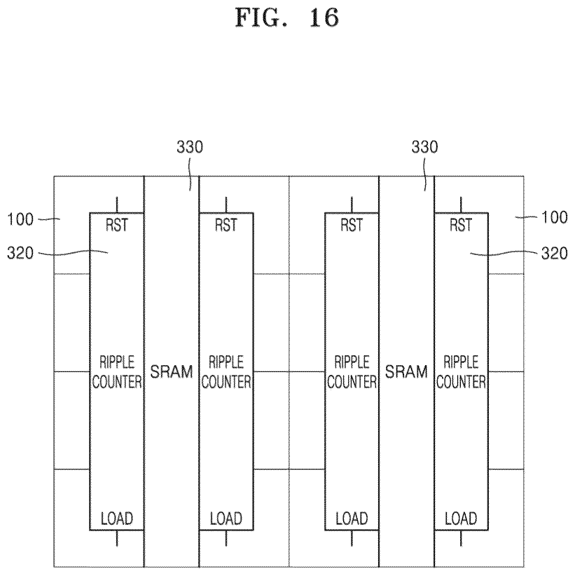

Also, in addition to the SRAM 330, the ripple counter 320 may be connected to a certain number of pixels 100 in common. As illustrated in FIG. 14, the SRAM 330 may be connected to four pixels 100 in common, and the ripple counter 320 may be connected to two pixels 100 in common. As another example, as illustrated in FIG. 15, the SRAM 330 may be connected to eight pixels 100 in common, and the ripple counter 320 may be connected to two pixels 100 in common. As another example, as illustrated in FIG. 16, the SRAM 330 may be connected to eight pixels 100 in common, and the ripple counter 320 may be connected to four pixels 100 in common.

Also, in addition to the SRAM 330 and the ripple counter 320, the ADC 310 may be connected to a certain number of pixels 100 in common.

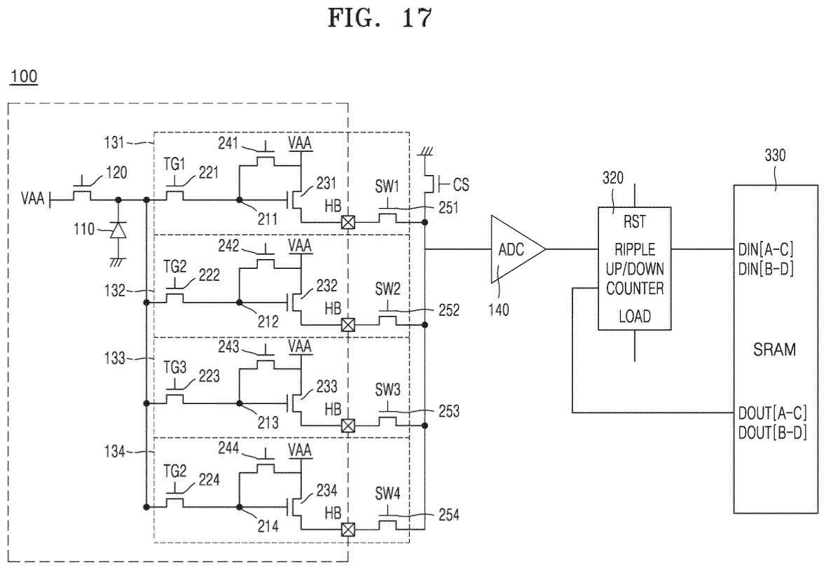

One or more embodiments may be described with reference to FIGS. 17 to 19. According to one or more embodiments, a difference value of a digital value may be maintained (stored).

FIG. 17 is a diagram illustrating a schematic configuration of a pixel 100 of a solid-state imaging device 20 according to one or more embodiments. As illustrated in FIG. 17, the pixel 100 may include a PD 110, a charge discharge transistor 120, first to fourth signal generators 131 to 134, an ADC 310, a ripple up/down counter 325, and SRAM 330.

The ripple up/down counter 325 may add a difference value A-C between a digital value of a tap A Tap_A and a digital value of a tap C Tap_C to a difference value B-D between a digital value of a tap B Tap_B and a digital value of a tap D Tap_D. The ripple up/down counter 325 may count the digital value of the tap A and the digital value of the tap B by using an up counter and may count the digital value of the tap C and the digital value of the tap D by using a down counter, and thus, may add a difference value. A summed value of the difference value A-C and a summed value of the difference value B-D may be maintained (stored) in the SRAM 330. In other words, a difference value between a summed value of the digital value of the tap A Tap_A and a summed value of the digital value of the tap C Tap_C and a difference value between a summed value of the digital value of the tap B Tap_B and a summed value of the digital value of the tap D Tap_D may be maintained (stored) in the SRAM 330.

Based on such a configuration, because a difference value used in distance is previously calculated, a distance to a subject may be calculated (obtained) for a relatively short time. Furthermore, a memory area may be reduced compared to a case where digital values of four taps are maintained (stored).

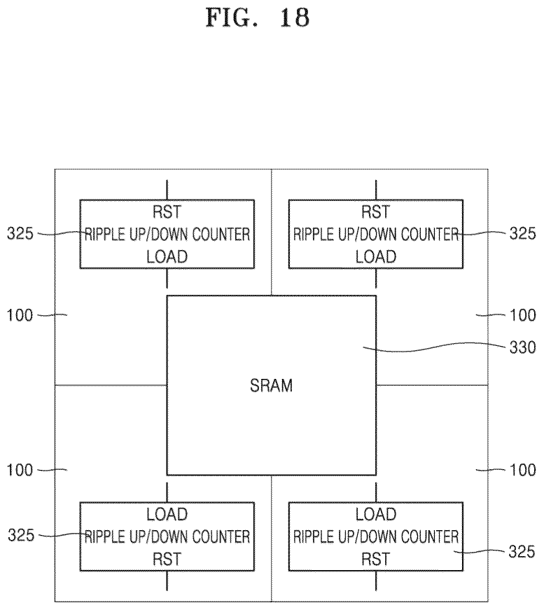

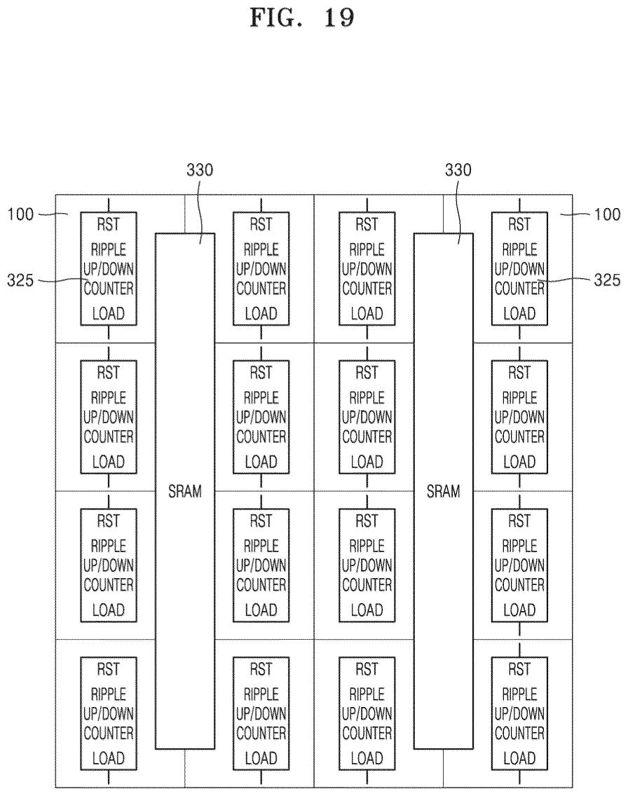

The ripple up/down counter 325 or the SRAM 330 may be connected to a certain number of pixels 100 in common. For example, as illustrated in FIG. 18, the SRAM 330 may be connected to four pixels 100 in common. Alternatively, as illustrated in FIG. 19, the SRAM 330 may be connected to eight pixels 100 in common.

Embodiments are not limited to the embodiments described above and may be variously modified in claims.

For example, in one or more embodiments, a case where one pixel includes two or four FDs has been described for example. However, the number of charge accumulators accumulating electric charges generated by a PD is not limited to the embodiments, and for example, one pixel may include three FDs.

Also, in the embodiments, an example where a memory maintaining a digital value is SRAM has been described for example. However, a memory maintaining a digital value may be dynamic RAM (DRAM).

Also, in the embodiments, an example where one ADC integrator or ADC is installed in each pixel has been described for example. However, a plurality of ADC integrators or ADCs may be installed in one pixel. For example, ADC integrators or ADCs equal to the number of FDs may be installed in one pixel.

While embodiments have been described with reference to the figures, it will be understood by those of ordinary skill in the art that various changes in form and details may be made therein without departing from the spirit and scope as defined by the following claims and their equivalents.

What is claimed is:

1. A solid-state imaging device comprising:
at least one pixel comprising:
a photoelectric converter configured to photoelectrically convert light to generate electric charge;
a plurality of charge accumulators respectively configured to accumulate the electric charge generated by the photoelectric converter; and
a plurality of transfer transistors respectively configured to control transfer of the electric charge from the photoelectric converter to the plurality of charge accumulators;
a converter connected to the at least one pixel and configured to generate a digital value based on an amount of electric charge accumulated in the plurality of charge accumulators;
a memory connected to the at least one pixel and configured to store the digital value;
an adder connected to the at least one pixel and configured to add the digital value, generated by the converter, to a digital value previously stored in the memory; and
a driver configured to add a digital value based on the amount of electric charge accumulated in one of the plurality of charge accumulators in a subframe next to a certain subframe, to a digital value based on the amount of electric charge accumulated in one of the plurality of charge accumulators in the certain subframe, and control the plurality of transfer transistors to store a summed value in the memory.

2. The solid-state imaging device of claim 1, wherein each of the plurality of transfer transistors is further configured to be turned on at different phase timings for each subframe among a plurality of continuous subframes.

3. The solid-state imaging device of claim 1, wherein each of the plurality of transfer transistors are further configured to be turned on in different orders for each subframe among a plurality of continuous subframes.

4. The solid-state imaging device of claim 1, wherein the memory is further configured to store a summed value of a plurality of digital values based on an amount of electric charge accumulated in different charge accumulators among the plurality of charge accumulators for each subframe among a plurality of continuous subframes.

5. The solid-state imaging device of claim 1, wherein the memory is further configured to store a summed value of a plurality of digital values based on the amount of electric charge accumulated in different charge accumulators among the plurality of charge accumulators at a same phase timing for each subframe among a plurality of continuous subframes.

6. The solid-state imaging device of claim 1, wherein the memory is further configured to store a difference between a summed value of a plurality of digital values based on the amount of electric charge accumulated in different charge accumulators among the plurality of charge accumulators at a first phase timing and a summed value of a plurality of digital values based on the amount of electric charge accumulated in different charge accumulators among the plurality of charge accumulators at a second phase timing differing from the first phase timing, in a plurality of continuous subframes.

7. The solid-state imaging device of claim 1, further comprising a plurality of charge memories between the plurality of charge accumulators and the plurality of transfer transistors, the plurality of charge memories being configured to store the electric charge generated by the photoelectric converter.

8. The solid-state imaging device of claim 1, wherein at least one of the converter, the memory, and the adder is connected to the at least one pixel in common.

9. The solid-state imaging device of claim 1, wherein the converter and the adder are integrally formed.

10. The solid-state imaging device of claim 1, wherein the adder comprises a ripple counter.

11. The solid-state imaging device of claim 1, wherein the memory comprises a plurality of taps connected to the at least one pixel.

12. The solid-state imaging device of claim 1, wherein the memory comprises one of static random-access memory (SRAM) and dynamic random-access memory (DRAM).

13. The solid-state imaging device of claim 1, wherein the at least one pixel comprises two photoelectric converters.

14. The solid-state imaging device of claim 1, wherein the solid-state imaging device comprises a first layer comprising the photoelectric converter and a second layer comprising the memory, and
wherein the first layer and the second layer are stacked.

15. A solid-state imaging device comprising:
a pixel array comprising a plurality of pixels; and
a driver configured to generate a driving signal,
wherein each of the plurality of pixels comprises:
a photodiode configured to photoelectrically convert light to generate electric charge;
a plurality of signal generators respectively configured to accumulate the electric charge generated by the photodiode and output a voltage based on an amount of accumulated electric charge;
an analog-to-digital converter (ADC) integrator configured to convert the voltage into a first digital value and add the first digital value to a second digital value; and
a memory configured to store the first digital value and the second digital value,
wherein the second digital value is a digital value previously stored in the memory, and
wherein the driving signal is a signal configured to control a first signal generator of the plurality of signal generators to output a voltage based on the amount of electric charge accumulated in the first signal generator in a certain subframe and a second signal generator of the plurality of signal generators to output a voltage based on the amount of electric charge accumulated in the second signal generator of the plurality of signal generators in a subframe adjacent to the certain subframe.

16. The solid-state imaging device of claim 15, wherein the pixel array is configured to generate a pixel signal, based on a digital value generated by the ADC integrator, and
wherein the solid-state imaging device further comprises at least one processor configured to obtain a distance from the solid-state imaging device to a subject, based on the pixel signal received from the pixel array.

17. The solid-state imaging device of claim 15, wherein each of the plurality of signal generators comprises:
a charge accumulator configured to accumulate the electric charge generated by the photodiode; and
a transfer transistor configured to control transfer of the electric charge to the charge accumulator from the photodiode.

18. The solid-state imaging device of claim 15, wherein each of the plurality of signal generators comprises a transfer transistor configured to be turned on at different phase timings for each subframe among a plurality of continuous subframes.

19. The solid-state imaging device of claim 15, wherein each of the plurality of signal generators comprises a transfer transistor configured to be turned on in different orders for each subframe among a plurality of continuous subframes.

20. An operating method of a solid-state imaging device including a plurality of charge accumulators, a memory, and an adder, the operating method comprising:
accumulating electric charge at different phase timings for each subframe among a plurality of continuous subframes based on the plurality of charge accumulators;
generating a digital value corresponding to the different phase timings based on the amount of electric charge accumulated by the adder; and
adding the digital value to a digital value previously stored in the memory, based on the adder,
wherein the digital value previously stored in the memory is a digital value added by the adder in a subframe preceding a certain subframe, where the digital value is generated, of the plurality of continuous subframes.
